(19) United States
(12) Patent Application Publication
(10) Pub. No.: US 2013/0214975 A1
(43) Pub. Date: Aug. 22, 2013

(54) TARGET LOCATION POSITIONING METHOD AND DEVICE

(71) Applicant: G. EDZKO SMID, OAKLAND TOWNSHIP, MI (US)

(72) Inventor: G. EDZKO SMID, OAKLAND TOWNSHIP, MI (US)

(73) Assignee: iTRACK, LLC, ROCHESTER, MI (US)

(21) Appl. No.: 13/632,413

(22) Filed: Oct. 1, 2012

Related U.S. Application Data
(60) Provisional application No. 61/541,529, filed on Sep. 30, 2011.

(51) Int. Cl. G01S 5/02

(52) U.S. Cl. CPC G01S 5/02
USPC 342/463

(57) ABSTRACT

An inventive precision pinpoint tracking method and system is provided for devices that provide spot location measurements of objects. Embodiments of the location measuring device have a RF antenna, a tracking module in electrical communication with the RF antenna, and a tilt-compensated (TC) compass. In embodiments of the location measuring device, a measuring tip is offset at a distal end from the tracking module and the RF antenna is located at the proximal end of the tracking module. In embodiments, the TC compass provides data to calculate a translation of the position of the measuring tip with respect to the RF antenna to enable spot measurements of locations of a target object.

### CROSS-REFERENCE TO RELATED APPLICATIONS

This application is a non-provisional application that claims priority benefit of U.S. Provisional Application Ser. No. 61/541,529, filed Sep. 30, 2011 the contents of which are hereby incorporated by reference.

### FIELD OF THE INVENTION

The present invention in general relates to location measurement, and in particular to a device for providing spot location measurements of objects.

### BACKGROUND OF THE INVENTION

The Global Positioning System (GPS) is based on the fixed location base stations and the measurement of time-of-flight of accurately synchronized station signature transmissions. The base stations for the GPS are satellites and require atomic clocks for synchronization.

GPS has several draw backs including relatively weak signals that do not penetrate heavy ground cover and/or man made structures. Furthermore, the weak signals require a sensitive receiver. GPS also utilizes a single or narrow band of frequencies that are relatively easy to block or otherwise jam, and can easily reflect to surfaces, resulting in multi-path errors. The accuracy of the GPS system relies heavily on the use of atomic clocks, which are expensive to make and operate.

U.S. Pat. No. 7,403,783 entitled “Navigation System,” herein incorporated in its entirety by reference, improves the responsiveness and robustness of location tracking provided by GPS triangulation, by determining the location of a target unit (TU) in terrestrial ad hoc, and mobile networks. The method disclosed in U.S. Pat. No. 7,403,783 includes initializing a network of at least three base stations (BS) to determine their relative location to each other in a coordinate system. The target then measures the time of difference arrival of at least one signal from each of three base stations. From the time difference of arrival of signals from the base stations, the location of the target on the coordinate system can be calculated directly. Furthermore, the use of high frequency ultra-wide bandwidth (UWB) wireless signals provide for a more robust location measurement that penetrates through objects including buildings, ground cover, weather elements, etc., more readily than other narrower bandwidth signals such as the GPS. This makes UWB advantageous for non-line-of-sights measurements, and less susceptible to multipath and canopy problems. While existing RF (radio frequency) position tracking systems can determine the location of an antenna within a tracking space, this position is different from the location of the antenna that is in communication with the tracking devices.

However, it may be necessary to determine the relative position or distance of certain locations within an area of operation, or on an object of interest. If the area of operation or the object of interest is indoors, then GPS coordinates may not be available. In other cases, the locating device may be a sensor or a probe that has to be placed in close proximity to the location of interest, and there is no space available for the antenna to measure the location.

Thus, there exists a need for a device and method for providing spot location measurements of objects that are not readily accessible. Furthermore, it would also be advantageous to have a spot measurement system that overcomes the limitations of GPS technology. There also exists as need for the ability to known the exact location of a specific spot on the tracking module, which is not the same as the antenna position.

### SUMMARY OF THE INVENTION

An inventive precision pinpoint tracking method and system is provided for devices that provide spot location measurements of objects. Embodiments of the location measuring device have a RF antenna, a tracking module in electrical communication with the RF antenna, and a tilt-compensated (TC) compass. In embodiments of the location measuring device, a measuring tip is offset at a distal end from the tracking module and the RF antenna is located at the proximal end of the tracking module. In embodiments, the TC compass provides data to calculate a translation of the position of the measuring tip with respect to the RF antenna to enable spot measurements of locations of a target object.

The tracking module, of embodiments of the location measuring device, includes in some embodiments at least one additional components of a three-dimensional (3D) accelerometer, a 3D compass, a 3D Gyroscopic sensors, a rechargeable battery, and microcontroller with software. The target location tracking module may also, in specific embodiments, a user interface capabilities such as a display, LED indicators, buttons, or an audio speaker.

In certain, the measuring tip of the location measuring device may be mounted on the end of an extending wand or telescopic extension, or the measuring tip may be formed with the crosshair intersection of two laser beams emanating from the inventive locating device.

### BRIEF DESCRIPTION OF THE DRAWINGS

FIG. 1 is a perspective view of an embodiment of the inventive location measurement device;

FIG. 2 is a representation of an embodiment of the location measurement device with intersecting laser beams forming the measurement tip for spot location measurements;

FIG. 3 is a schematic diagram of the electronic components that form a tilt-compensated (TC) compass to determine the offset of the measurement tip; and

FIG. 4 is a schematic representation of the inventive handheld location measurement device illustrating roll, pitch and yaw measurement determined from 3D accelerometers and 3D magnetic sensors.

### DETAILED DESCRIPTION OF THE PREFERRED EMBODIMENTS

An inventive precision pinpoint tracking method and device has utility in spot location measurements of objects. Embodiments of the inventive system may include a radiofrequency (RF) position tracking system, such as the tracking system disclosed in U.S. Pat. No. 7,403,783 with a target location tracking module that includes antenna, 3D accelerometer, 3D compass, 3D Gyroscopic sensors, a rechargeable battery, and microcontroller with software. The target location tracking module in some embodiments include user interface capabilities such as a display, LED indicators, buttons, or an audio speaker.

Existing RF (radio frequency) position tracking systems can determine the location of an antenna within a tracking space. However, it is often desirable to know the exact location of a specific location on the tracking module, which is different from the location of the antenna that is in communication with the tracking devices. In embodiments, the antenna of a tracking module is attached to a handheld device with a locating tip mounted on the end of an extending wand or telescopic extension. The tip of the device to then positioned at a reference location from which the 2D/3D position is measured. In this case, the device may be a sensor or a probe that has to be placed in close proximity to the location of measurement interest, and there is no space available for the antenna to measure the location. Furthermore, in order to acquire good radio signal from the antenna, such that good quality range measurements are collected, it is typically desirable to have clearance around the antenna, away from surfaces and objects. The antenna and tracking module can then be placed at an offset from the sensor or probe, and the translation from the antenna to the tip of the sensor or probe are in certain embodiments used to determine the location.

In another embodiment, the measurement tip is formed with the crosshair intersection of two laser beams emanating from the inventive locating device. The use of laser beams can serve as the pin-point measurement tip for the position tracking device when the desired measurement location is behind an optically transparent barrier such as glass; too far away to reach with the wand or telescopic extension absent cantilevered deformation; at an extreme condition as to a variable such as heat, radiation, cleanliness or combination thereof; or certain locations that may not be easily reachable or accessible. The angles of the laser beams are amenable to being dynamically adjusted to extend the crosshair that indicates the measuring tip.

In certain other embodiments, the tracking module first calculates the position of the antenna with RF tracking in a network, and subsequently calculates the position of the pointing tip by adding the translation from the antenna to the tip, translated in space by the roll, pitch and heading. The roll, pitch, and heading are measured with the 3D accelerometer, and 3D compass (3D magnetic sensors), configured as a tilt-compensated (TC) compass. A tilt compensated Compass is a device that can measure an object's horizontal orientation (i.e., direction within Earth's magnetic field) for any arbitrary orientation of that object in the vertical field (i.e., roll and pitch). In other words, for any forward or sideways rotation, a TC device will calculate the heading relative to the North Pole. The ability to acquire roll and pitch angles relative to gravity, and heading angle relative to earth magnetics' field are conventional knowledge as detailed for instance in AN3192 by STMicroelectronics. In instances where the reference frame of the RF position tracking system is orientated with a known orientation in the global coordinate system, then the heading from the TC compass can be related to the orientation within the RF reference frame. In general, the RF position tracking system in certain inventive embodiments is not related to the global coordinate system, but to an ad-hoc system of locating base stations, and a calibration procedure takes place to correlate the TC compass measurement to the orientation within the reference frame of the RF positioning system.

In other inventive embodiments, the translation from the antenna to the measuring tip of the tracking device must be known accurately and in the proper orientation to properly determine the location of an object or point in space. It is appreciated that the translation can be described in various coordinate systems, with the choice being often dictated by ease of computation or interface with other components or devices. These coordinate systems in 3D illustratively include Cartesian coordinates (x, y, z) spherical coordinates (azimuth, elevation, distance), or cylindrical coordinates (azimuth, elevation, z).

In certain inventive embodiments the device integrates the use of the TC compass with RF position tracking systems. As a result, with a relatively simple calibration process that integrates operation of these two different and unrelated systems that would otherwise operate in separate coordinate reference frames, to now provide accurate position tracking.

Calibration of the inventive location measurement device is readily accomplished by manually entering translation vectors for offsetting the location of the measuring tip, or by the following calibration sequence:
1. An arbitrary position “P” in space is selected that is easily accessible, and is unobstructed, so that good positioning information can be acquired, the inventive tracking device is held, such that the antenna is exactly at “P”. This location of the antenna is recorded as “L1”.
2. The measuring tip of the tracking device is then pointed at “P”. In a 2D, or pseudo 3D, positioning system, where no accurate value for the third dimension can be acquired, make sure to position the tracking device such that both the antenna and the measuring tip are in the same plane with the RF tracking reference frame. This constraint is not required for a 3D position inventive tracking system.
3. The orientation of the tracking device is co-aligned with the orientation of the tracking reference frame. This location of the antenna is recorded as “L2”. The inventive device is able to confirm that the device is co-aligned, since L1 and L2 must have the same value for the y-coordinate, and that the x-coordinate of L2 must be smaller than the x-coordinate of L1 in Cartesian coordinates.
4. The translation distance between the antenna and the measurement tip is determined as the distance between L1 and L2. In the 2D positioning system, this is the difference in the values for the x-coordinate in Cartesian coordinates. In the 3D system this distance is the linear distance in the x-z-plane between L1 and L2 in Cartesian coordinates.
5. When L2 is recorded, the global orientation as measured with the TC compass is registered as the orientation of the RF tracking reference frame “H0”. The H0 orientation can be subtracted from any subsequent heading measurement from the TC compass, to give the orientation within the RF tracking reference frame.
6. When L2 is recorded, also the roll and pitch angles are registered as the horizontal orientation of the RF reference frame. Subsequent measurements for roll and pitch can be used to project the translation from the antenna to the measurement tip, as to provide the location of the tip of the device.

The translation distance may be expressed by the mathematical formulation as follows:

$${[ \begin{matrix}x \\ y \\ z\end{matrix} ]}_{tip} = {R}_{z} {R}_{y} {{R}_{x} [ \begin{matrix}x \\ y \\ z\end{matrix} ]}_{antenna}$$

$$where$$

$${R}_{x} = [ \begin{matrix}1 & 0 & 0 \\ 0 & cos α & - sin α \\ 0 & sin α & cos α\end{matrix} ] , {R}_{y} = [ \begin{matrix}cos ϕ & 0 & sin ϕ \\ 0 & 1 & 0 \\ - sin ϕ & 0 & cos ϕ\end{matrix} ] , and$$

$${R}_{z} = [ \begin{matrix}cos θ & - sin θ & 0 \\ sin θ & cos θ & 0 \\ 0 & 0 & 1\end{matrix} ]$$

Where α is the roll, φ is the pitch, θ and is the yaw.

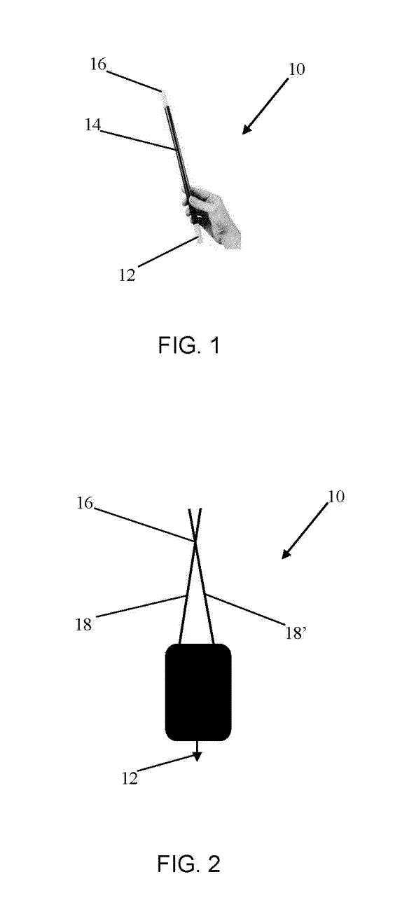

Referring now to FIGS. 1 and 2, an inventive locating device, is depicted, generally at 10. The locating device 10 includes an RF antenna 12 positioned at a proximal end of a extending wand or telescopic extension 14, and a measuring tip 16 mounted at the distal end of the extending wand or telescopic extension 14. Mounted within the extending wand or telescopic extension 14 is a 3D accelerometer, 3D compass, and microcontroller with software for configuring a tilt-compensated (TC) compass to perform the translation calculations between the RF antenna 12 and the measuring tip 16.

FIG. 2 illustrates an embodiment of the inventive locating device 10, where the measurement tip 16 is formed with the crosshair intersection of two laser beams (18, 18′) emanating from the inventive locating device 10. The use of laser beams is well suited as the pin-point measurement tip 16 for the locating device 10 when the desired measurement location is behind glass, too far away to reach with the wand or extension, at an extreme condition, or certain locations that may not be easily reachable. The angles of the laser beams may be adjusted to extend the crosshair that indicates the measuring tip 16.

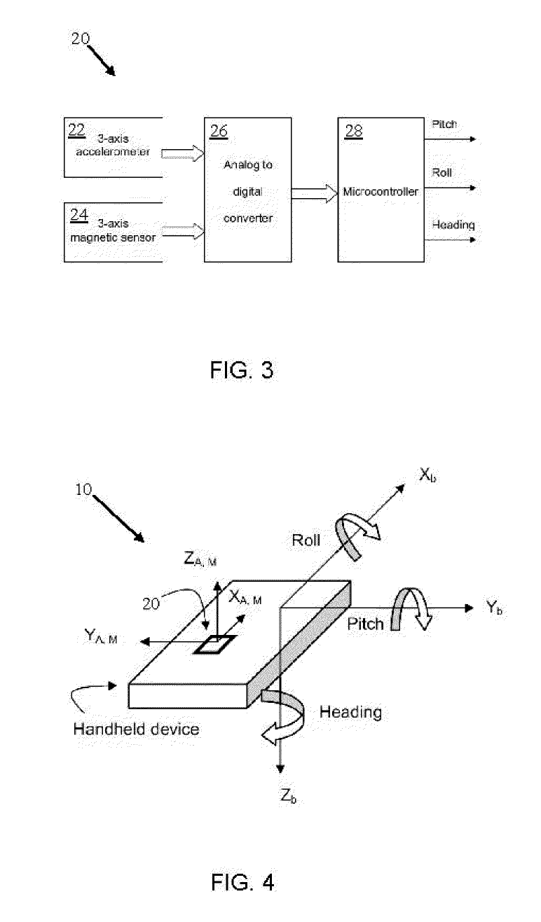

FIG. 3 is a schematic diagram of the electronic components that form a tilt-compensated (TC) compass 20 to determine the offset of the measurement tip from the RF antenna. The TC compass 20 operates by taking the output (analog) readings of a 3-axis accelerometer 22 and the output (analog) readings of a 3-axis magnetic sensor 24 and applying the readings to an analog to digital (A/D) converter 26, which then provides a digital data stream to a microcontroller 28 configured with software to calculate parameters including pitch, roll, and heading. Data storage (not shown) for the locations allows for spot location to be transferred to a remote computer for storage or subsequent navigation to revisit the target relative to the spot locations by the same inventive device or another device. It should be appreciated that data transfer can be accomplished by direct or wireless connection. A wireless transceiver is provided for communication of the location data to a remote storage device. The collection of this data makes the present invention particularly well suited for usage in a variety of applications including forensics, archaeology, quality control, engineered structure maintenance, mineral exploration, surgical procedures, surveying, and mine clearing.

FIG. 4 is a schematic representation of the inventive handheld location measurement device 10 illustrating roll, pitch and yaw measurement determined from the TC compass 20 in Cartesian coordinates. TC compass 20 may be implemented as an integrated circuit (IC) such as an LSM303DLH available from STMiroelectronics (Geneva, CH).

The orientation information of the handheld location measurement device 10 can now be used to enhance the accuracy of the RF position tracking system, depending on the operating scenario. Since the orientation of the handheld location measurement device 10 is typically associated with the location of the object or surface to be measured, it is possible to derive a reasonable estimation of the relative location of the object or surface to be measured relative to the handheld location measurement device 10. Depending on the material properties of the object or surface, it may be desirable to eliminate any range measurements that were acquired in the direction of the object or surface, since these measurements are likely to be non-line-of-sight, and therefore less accurate in terms of range determination. For example, it will be more likely that a range measurement was determined from an indirect path rather than the direct path, if the object or surface is opaque to the frequencies that are used by the RF position tracking system. With the knowledge of the current orientation and position, and with knowledge of the beacon locations for tracking, the system will be able to determine the direction of each of the range measurements to each of the beacons, and add a level of confidence to each of the measurements, depending on the reasonable estimation of the relative location of the object or surface to the handheld location measurement device.

The foregoing description is illustrative of particular embodiments of the invention, but is not meant to be a limitation upon the practice thereof. The following claims, including all equivalents thereof, are intended to define the scope of the invention.

1. A location measuring device to enable spot measurements of a location of a target, said device comprising:
a RF antenna having an antenna position;
a tracking module in electrical communication with said RF antenna and a tilt-compensated (TC) compass;
a measuring tip having a tip position extending from said tracking module and said RF antenna located at the proximal end of said tracking module, said TC compass provides data to calculate a translation of the tip position with respect to the antenna position to enable the spot measurements of the locations of the target.

2. The device of claim 1 wherein said measuring tip is offset at a distal end from said tracking module and said RF antenna with an extending wand or telescopic extension.

3. The device of claim 2 wherein said tracking module and said tilt-compensated (TC) compass is located on or within said extending wand or telescopic extension.

4. The device of claim 1 wherein said measuring tip corresponds to the crosshair intersection of two laser beams emanating from said tracking module.

5. The device of claim 4 wherein the offset of said measuring tip is dynamically adjusted by altering the angles of said laser beams.

6. The device of claim 1 wherein said tracking module further comprises at least one of a 3D accelerometer, a 3D compass, a 3D Gyroscopic sensor, a rechargeable battery, and a microcontroller with software.

7. The device of claim 1 wherein said tracking module further comprises a user interface including one or more of a display, LED indicators, buttons, and an audio speaker.

8. The device of claim 1 further comprising a data storage memory.

9. The device of claim 8 further comprising a wireless transceiver for communicating data of the locations.

10. A system for spot location measurements of objects, said system comprising:
at least three or more base stations;
a location measuring device of claim 1.

11. The system of claim 10 wherein said tracking module communicates via said RF antenna with said at least three or more base stations to determine a location of said RF antenna.

12. The system of claim 10 wherein said at least three or more base stations are formed in an ad hoc network communicating via high frequency ultra-wide bandwidth (UWB) wireless signals.

13. The system of claim 10 wherein said at least three or more base stations form a mobile network.

14. A method for using the location measuring device of claim 1, said method comprising:
placing said measuring tip on an object to be positioned measured;
calculating a position of said RF antenna with at least three or more base stations; and
calculating a translation position of said measuring tip with respect to said RF antenna calculated position using said TC compass to enable spot measurements of locations of a target.

15. The method of claim 14 further comprising data storage of the spot measurement of the locations of the target.

16. The method of claim 15 further comprising wirelessly transferring the data storage to a remote storage.

17. The method of claim 14 further comprising subsequently revisiting the target using the spot measurements of the locations.
